(19) United States
(12) Patent Application Publication
(10) Pub. No.: US 2022/0148023 A1
(43) Pub. Date: May 12, 2022

(54) TOOL FOR DETERMINING PRICING FOR REINSURANCE CONTRACTS

(71) Applicant: Assured Inc., Wellesley, MA (US)

(72) Inventors: Afik GAL, Needham, MA (US); Yariv Dror MIZRACHI, Ra'anana (IL)

(21) Appl. No.: 17/524,069

(22) Filed: Nov. 11, 2021

Related U.S. Application Data
(60) Provisional application No. 63/112,789, filed on Nov. 12, 2020.

(51) Int. Cl. G06Q 30/02; G06Q 40/08

(52) U.S. Cl. CPC G06Q 30/0206; G06Q 40/08

(57) ABSTRACT

A pricing determiner for a reinsurance contract includes at least one database and a processor. The database stores block data of a block of policy holders and externally gathered data, a least a portion of which is related to the policy holders. The processor implements a reinsurance pricing determiner which includes a model builder, a probability function generator and a pricing determiner. The model builder predicts which policy holders will have an event on their policies and within what time frame and is operative on the block data and the externally gathered data. The probability function generator generates a probability function from the model, the block data, and the externally gathered data. The pricing determiner activates the probability function generator on different portions of the policy holders and generates from the resultant probability functions a price for the reinsurance bracketed within a price range.

### CROSS REFERENCE TO RELATED APPLICATIONS

This application claims priority from U.S. provisional patent application 63/112,789, filed Nov. 12, 2020, which is incorporated herein by reference.

### FIELD OF THE INVENTION

The present invention relates generally to tools for insurance.

### BACKGROUND OF THE INVENTION

Insurers insure many things, among them are medical care, long term care and death risks. To do so, they maintain reserves to cover expected payouts and they charge premiums according to actuarial predictions on the insured policies. The actuarial predictions are based on underwriting data (which, for medical policies, may include age, gender, medical conditions, etc.) and policy information that the insurer gathers (customer's reason for buying the policy and the later cost of claims).

Due to financial and regulatory reasons, insurers often need to transfer some or all of the risk for a “block” of policies to a reinsurer. The policies can be packaged into blocks in any way, such as by types of products, state or country of origin, etc.

For each block, the potential reinsurer may check the block and may then use its own determination to price the risk for the block. If the insurance company, or “carrier”, agrees to the price, the potential reinsurer may then buy the block at the agreed upon price, less a ceding commission for moving the risk onto the reinsurer's books. The insurance company may then also transfer an agreed upon amount of reserves to the reinsurer to cover the expected payouts.

### SUMMARY OF THE PRESENT INVENTION

There is therefore provided, in accordance with a preferred embodiment of the present invention, a pricing determiner for a reinsurance contract. The determiner includes at least one database storing block data of a block of policy holders and externally gathered data, a least a portion of which is related to the policy holders, and a processor implementing a reinsurance pricing determiner. The determiner includes a model builder, a probability function generator and a pricing determiner. The model builder predicts which policy holders of the block of policy holders will have an event on their policies and within what time frame and is operative on the block data and the externally gathered data. The probability function generator generates a probability function from the model, the block data, and the externally gathered data. The pricing determiner activates the probability function generator on different portions of the policy holders and generates from the resultant probability functions a price for the reinsurance contract bracketed within a price range indicative of a risk level in the price.

Moreover, in accordance with a preferred embodiment of the present invention, the externally gathered data is assessment data and/or research data. The assessment data is from at least one of: questionnaires and professional assessment visits to at least one of the policy holders.

Further, in accordance with a preferred embodiment of the present invention, the probability function generator includes a base index calculator to determine a base index for a reinsurance estimate and a noise estimator to estimate an amount of noise in the base index.

Moreover, in accordance with a preferred embodiment of the present invention, the noise estimator includes a statistical noise determiner to determine a statistical noise, a partial data noise determiner to determine a partial data noise caused when the model only poorly matches the block data and the externally gathered data or if the model is estimated with only partial information, a trend noise determiner to determine a trend noise due to errors in previous years' calculations, and an overall noise determiner to determine the amount of noise in the base index from the statistical noise, the partial data noise and the trend noise.

Further, in accordance with a preferred embodiment of the present invention, the probability function is a Gaussian function with the base index as its mean and the amount of noise as its standard deviation.

There is also provided, in accordance with a preferred embodiment of the present invention, a method for determining pricing for a reinsurance contract. The method includes storing block data of a block of policy holders and externally gathered data, a least a portion of which is related to the policy holders, predicting which policy holders of the block of policy holders will have an event on their policies and within what time frame, the predicting operative on the block data and the externally gathered data, generating a probability function from the model, the block data, and the externally gathered data, activating the generating on different portions of the policy holders, and calculating from resultant probability functions a price for the reinsurance contract bracketed within a price range indicative of a risk level in the price.

Moreover, in accordance with a preferred embodiment of the present invention, the externally gathered data is assessment data and/or research data The assessment data is from at least one of: questionnaires and professional assessment visits to at least one of the policy holders.

Further, in accordance with a preferred embodiment of the present invention, the generating includes determining a base index for a reinsurance estimate, and estimating an amount of noise in the base index.

Still further, in accordance with a preferred embodiment of the present invention, the estimating includes determining a statistical noise, determining a partial data noise caused when the model only poorly matches the block data and the externally gathered data or if the model is estimated with only partial information, determining a trend noise due to errors in previous years' calculations, and determining the amount of noise in the base index from the statistical noise, the partial data noise and the trend noise.

Finally, in accordance with a preferred embodiment of the present invention, the probability function is a Gaussian function with the base index as its mean and the amount of noise as its standard deviation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of a reinsurance pricing determiner and its environment; and

FIG. 2 is a block diagram illustration of the elements of the reinsurance pricing determiner of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that sometimes, the carrier and reinsurer sometimes do not agree on the amount of reserves that the carrier should transfer to the reinsurer to cover the expected payouts. Such disagreements prevent deals from happening.

Applicant has realized that, since the amount of reserves to be transferred is linked to the “expected value” of the block (i.e., the expected premiums vs. the expected cost of claims over the lifetime of the policies) and to its risk level, trend analyses using a wide set of policyholder related data and research about life expectancy, as well as considering many different scenarios in order to give an indication of the quality of the estimate, may provide a better prediction of the risk, and thus, may enable the reinsurance deals to happen.

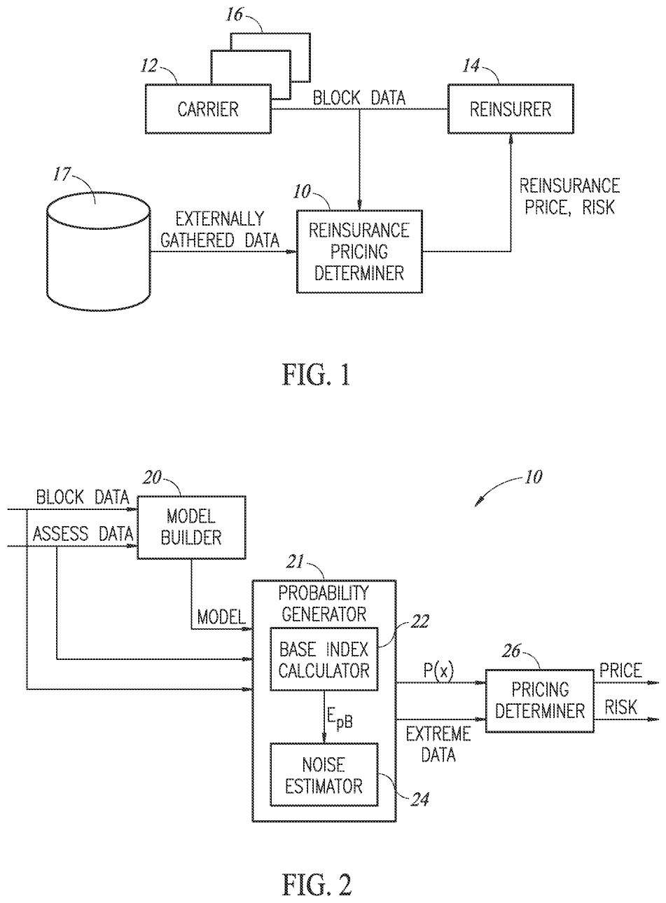

Reference is now made to FIG. 1, which illustrates a reinsurance pricing determiner 10, a tool to evaluate a block 16 of insurance policies originally issued by a carrier 12 and now available for sale to a reinsurer 14. Specifically, determiner 10 may determine the risk levels associated with block 16, using a broader set of data than used by reinsurer 14 when evaluating block 16.

Initially, carrier 12 may provide data about block 16 to reinsurer 14. Without determiner 10, carrier 12 and reinsurer 14 may each generate an expected value, each using its own valuation system. For example, carrier 12 may determine that block 16 will have a $200 million liability while reinsurer 14 may determine that it will have a $280 million liability. Thus, there is a gap of $80 million between the two valuations.

Reinsurance pricing determiner 10 may generate an improved valuation with a stronger risk measurement. To do so, determiner 10 may receive the data of block 16, as well as externally gathered data, which may include assessment data related to the policy holders and/or research data, all shown stored in at least one database 17. The assessment data may be information from at least some of the policy holders of block 16 and the research data may be the results of various types of research about the effects of various life choices on life expectancy.

As shown in FIG. 2, to which reference is now made, determiner 10 may comprise a model builder 20, a probability generator 21, and a pricing determiner 26.

Applicant has realized that it is insufficient to just determine a price estimate as it doesn't indicate how risky the estimate is. Instead, determining a probability function for the estimates may help quantify the risk and that, to determine the probability, a mean and a standard deviation need to be determined. Accordingly, probability generator 21 may comprise a base index calculator 22 and a noise estimator 24.

Using at least the gathered data and the data from block 16, model builder 20 may build a mathematical model which may predict which insured persons of block 16 are more likely to make claims and within what time frame. Using the resultant model, base index calculator 22 may make an initial estimate E_{pB} of the expected payout for block 16, also known as a “base index”, and noise estimator 24 may determine a noise level in the data of block 16. Pricing determiner 26 may utilize the noise level to convert the base index into a price for the block and to define a risk level to the price.

Model builder 20 may perform a trend analysis F(x̅₁) on the data of block 16, where each vector x̅ⱼ is the data for the jth policy holder xⱼ, and on the externally gathered data. Any suitable trend analysis may be performed. For example, F(x̅₁) may be the predictive model described in U.S. Provisional Patent Application 63/068,062 and the model builder described in U.S. patent application Ser. No. 17/406,142, both of which are incorporated herein by reference and assigned to the common assignee of the present application.

Using at least the gathered data and the data from block 16, model builder 20 may build a mathematical model F(xⱼ) which may predict which policy holders of block 16 are more likely to make claims and within what time frame.

The model may be based on a predictive model of the type:

$$F ( {x}_{j} ) = \frac{{e}^{( \sum {α}_{1} p e t + {α}_{2} v o l u n t e e r + {α}_{3} walks + … )}}{1 + {e}^{( a g {e}^{2} + \sum {α}_{1} p e t + {α}_{2} v o l u n t e e r + {α}_{3} w a lks + … )}} \qquad ( 1 )$$

where F(xⱼ) is the probability that the jth policy holder xⱼ will have an event (file a claim dies or lapse the policy) at a given age. There may be different probability functions F(xⱼ) for each type of event.

The features (pet, volunteer, walks, etc.) are the non-medical and medical scores provided through assessments of policy holder xⱼ, such as questionnaires and/or professional assessments, or which may be deduced from research data, most of which scores are generally not available to insurance companies. For example, some non-medical features might be: things an insured person does, marital state, financial status, home ownership, social, smoker, etc., while some medical features might be those which can be measured at home, such as blood pressure, temperature, heart rate, etc. Each response on an assessment is scored and it is this score (1 or 0, per policy holder) which is used to define a value of a feature for determiner 10.

To generate the model, model builder 20 may perform a process similar to a logistic regression but one where one input is the age, another input is the square of the age, and some features, such as married and gender, may be co-dependent.

Once model builder 20 has generated the model of the data of block 16, it may provide the model to probability generator 21 who may, in turn, use the model, the block data and the gathered data to generate an estimate probability function.

Base index calculator 22 may run the model on the block data and the gathered data to generate the expected payout Eₚ(xⱼ) per policy holder xᵢ and per year of the calculation and may utilize these values to determine the base index E_{pB} for block 16.

Using the model, noise estimator 24 may generate an overall noise estimate from estimates of three types of noise: a statistical noise N_{A} which may be a standard noise calculation of the standard deviation, a partial data noise N_{B}, which may be a noise caused when the model only poorly matches the data or if the model is estimated with only partial information, and a trend noise error N_{C}, which may be a noise due to errors in previous years' calculations.

Statistical noise N_{A} is a standard deviation. Noise estimator 24 may calculate it by first generating an “effective” number of claims N_{E}:

$${N}_{E} = \frac{{E}_{p B}}{B p} \qquad ( 2 )$$

Where E_{pB} is the expected payout calculated by base index calculator 22, and Bp is an average payout per claim as provided by carrier 12. Noise estimator 24 may then generate the statistical noise N_{A} as the number of claims times the average payout per claim:

N_{A}=\sqrt{N_{E}}Bp (3)

Noise estimator 24 may calculate partial data noise N_{B} by running the model on different portions of the block data. Thus, for partial data noise N_{B}, noise estimator 24 may perform the following method:

Repeat K times:
a. Randomly pick a portion xₖ of policy holders;
b. Use the model on the block data and the gathered data for portion xₖ to generate an estimate F(x̅ₖ) for the portion;
c. Calculate a “partial data error” eₖ between the portion estimate and the initial estimate: eₖ=F(x̅ⱼ)−F(x̅ₖ)

The resultant error may be the difference between the estimate with full data and an estimate with partial data. Noise estimator 24 may generate partial data noise N_{B} by taking the average of the absolute values of the K partial data error values eₖ.

Noise estimator 24 may calculate trend noise error N_{C} by running the model on different years of the block data. Thus, for trend noise error N_{C}, noise estimator 24 may perform the following method:

For each year T:
a. Select x_{T}, which is all of the policy holders until year T;
b. Use the model on the block data and the gathered data for policy holders x_{T} until year T to generate estimates F(x̅_{T});
c. Calculate an “historical error” e_{T} between the estimate to year T and the estimate to the current year: e_{T}=F(x̅ⱼ)−F(x̅_{T})

This historical error defines the error of the “future”, from year T to now.

Noise estimator 24 may generate trend noise error N_{C} by taking the average of the historical errors e_{T}. If there isn't enough data in the block, noise estimator 24 may extrapolate the expected results where necessary.

Noise estimator 24 may generate the total noise N_{T} to be used in calculating a reinsurance price by determining a root-mean-square of the individual noises, as follows:

N_{T}=N_{A}²+N_{B}²+N_{C}² (4)

Probability generator 21 may define estimate probability function P(x̅) of the benefit, where P(x̅) has a distribution whose standard deviation is total noise N_{T} and whose mean is estimated payout E_{pB}

Pricing determiner 26 may determine a price PC of the reinsurance from estimated payout E_{pB} and total noise N_{T}. To determine price PC, pricing determiner 26 may calculate price PC from probability function P(x̅), as follows:

PC=∫₁^{J}∫₀^{∞}P(x̅)·PAY(x,t)dtdx (5)

where PAY(x,t) is the payment for a claim in year t and the calculation is over the J policy holders.

In accordance with a preferred embodiment of the present invention, pricing determiner 26 may determine risk levels or confidence levels for price PC, by repeating the calculation of price PC a plurality of times but each with a different portion of the policy holders. For example, for each of 1000 repetitions m, pricing determiner 26 may take a different 70% of the policy holders, may activate probability generator 21 on the set of policy holders, and may generate an interim price PCₘ from the resultant probability function. It will be appreciated that such a significant repetition of the calculation may provide confidence in the results and is not currently performed by actuaries.

Pricing determiner 26 may use interim prices PCₘ to provide a price range which may bracket the main price PC and may provide an indication of risk associated with the price. For example, pricing determiner 26 may rank the interim prices PCₘ and may average the highest 10% prices, to generate a high end PC_{high}, of the price range, and may average the lowest 10% of prices to generate a low end PC_{low} of the price range.

Pricing determiner 26 may then provide reinsurer 14 and/or carrier 12 with a reinsurance proposal listing price PC and its associated low and high prices PC_{low} and PC_{high}, respectively.

It will be appreciated that reinsurance pricing determiner 10 may incorporate externally gathered data, and a probability estimation in an attempt to generate a better estimate than the estimates of carrier 12 and reinsurer 14. Moreover, reinsurance pricing determiner 10 may repeat the calculation a statistically significant number of times to provide more information about the risk in the price. By defining the risk level, determiner 10 may enable reinsurer 14 to price the reinsurance at price lower than it that provided using its current tools or may enable carrier 12 to price the reinsurance at a price higher than that provided using its current tools.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general-purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A pricing determiner for a reinsurance contract, the determiner comprising:
at least one database storing block data of a block of policy holders and externally gathered data, a least a portion of which is related to said policy holders; and
a processor implementing a reinsurance pricing determiner, the determiner comprising:
a model builder to predict which policy holders of said block of policy holders will have an event on their policies and within what time frame, said model builder operative on said block data and said externally gathered data;
a probability function generator to generate a probability function from said model, said block data, and said externally gathered data; and
a pricing determiner to activate said probability function generator on different portions of said policy holders and to generate from resultant probability functions a price for said reinsurance contract bracketed within a price range indicative of a risk level in said price.

2. The pricing determiner of claim 1 wherein said externally gathered data is assessment data and/or research data.

3. The pricing determiner of claim 2 wherein said assessment data is from at least one of: questionnaires and professional assessment visits to at least one of said policy holders.

4. The pricing determiner of claim 1 wherein said probability function generator comprises:
a base index calculator to determine a base index for a reinsurance estimate; and
a noise estimator to estimate an amount of noise in said base index.

5. The pricing determiner of claim 4 wherein said noise estimator comprises:
a statistical noise determiner to determine a statistical noise;
a partial data noise determiner to determine a partial data noise caused when said model only poorly matches said block data and said externally gathered data or if said model is estimated with only partial information;
a trend noise determiner to determine a trend noise due to errors in previous years' calculations; and
an overall noise determiner to determine said amount of noise in said base index from said statistical noise, said partial data noise and said trend noise.

6. The pricing determiner of claim 4 wherein said probability function is a Gaussian function with said base index as its mean and said amount of noise as its standard deviation.

7. A method for determining pricing for a reinsurance contract, the method comprising:
storing block data of a block of policy holders and externally gathered data, a least a portion of which is related to said policy holders;
predicting which policy holders of said block of policy holders will have an event on their policies and within what time frame, said predicting operative on said block data and said externally gathered data;
generating a probability function from said model, said block data, and said externally gathered data;
activating said generating on different portions of said policy holders; and
calculating from resultant probability functions a price for said reinsurance contract bracketed within a price range indicative of a risk level in said price.

8. The method of claim 7 wherein said externally gathered data is assessment data and/or research data.

9. The method of claim 8 wherein said assessment data is from at least one of: questionnaires and professional assessment visits to at least one of said policy holders.

10. The method of claim 7 wherein said generating comprises:
determining a base index for a reinsurance estimate; and
estimating an amount of noise in said base index.

11. The method of claim 10 wherein said estimating comprises:
determining a statistical noise;
determining a partial data noise caused when said model only poorly matches said block data and said externally gathered data or if said model is estimated with only partial information;
determining a trend noise due to errors in previous years' calculations; and
determining said amount of noise in said base index from said statistical noise, said partial data noise and said trend noise.

12. The method of claim 10 wherein said probability function is a Gaussian function with said base index as its mean and said amount of noise as its standard deviation.
